(19) United States
(12) Patent Application Publication
(10) Pub. No.: US 2018/0332823 A1
(43) Pub. Date: Nov. 22, 2018

(54) ANIMAL ORAL HYGIENE CARE DEVICE AND METHOD OF USE

(71) Applicant: Jonathan Blaisdell, Weymouth, MA (US)

(72) Inventor: Jonathan Blaisdell, Weymouth, MA (US)

(21) Appl. No.: 15/983,585

(22) Filed: May 18, 2018

Related U.S. Application Data
(60) Provisional application No. 62/508,064, filed on May 18, 2017.

(51) Int. Cl. A01K 15/02

(52) U.S. Cl. CPC A01K 15/026

(57) ABSTRACT

Example embodiments of an animal (e.g., dog) oral hygiene care device are provided that promote interactive cleaning of the animal's through social interaction and “play.” Cleaning may be accomplished by effective brushing action that services areas of the mouth neglected by other cleaning devices, for example, both the inside and outside of the animal's teeth and gum line. The device may be structured to protect the human (e.g., owner) from injury (e.g., preventing bits or scrapes to their hands) while enhancing cleaning by dispensing toothpaste (e.g., flavored toothpaste).

### CROSS-REFERENCE TO RELATED APPLICATIONS

The present application claims the benefit of U.S. Provisional Patent Application Ser. No. 62/508,064, which was filed on May 18, 2017, by Jonathan Blaisdell for ANIMAL ORAL HYGIENE CARE DEVICE AND METHOD OF USE, which is hereby incorporated by reference.

### BACKGROUND

### Technical Field

The present disclosure relates to animal (e.g., dog) oral hygiene, and more specifically to an animal oral hygiene care device that encourages an animal's voluntary, active participation in dental cleaning.

### Background Information

Many animals, including family pets, suffer from substandard oral hygiene care. This problem is particularly prevalent with dogs. According to an article written by Dr. Roark, D V M, about 95% of dog owners do not regularly clean their dog's teeth. This substandard oral care can lead to a buildup of tarter and other bacteria on the teeth. While accumulated tarter and other bacterial buildup can be removed by a veterinarian in a clinic, the cost can be prohibitive due to the need of sedation for the animal and the high cost of anesthesia. Accordingly, it is often left untreated. Longstanding tarter and other bacterial buildup can eventually cause a bacterial infection in the gums, which if left unchecked, may spread through the blood stream and infect vital organs, causing serious health repercussions.

The current devices and techniques for cleaning an animal's teeth have a number of flaws. In the case of dogs, the most common techniques are owner-manipulated cleaning with a conventional “human” toothbrush, self-directed cleaning with dental chews, and self-directed cleaning with dental ropes. With owner-manipulated cleaning with a conventional “human” toothbrush, the owner takes a conventional toothbrush with a handle at one end with an assortment of bristles at the other and uses it to brush the dog's teeth. The owner must position the dog in a way that restricts its ability to move its head and mouth, while typically simultaneously lifting the dog's upper lips to expose its teeth for brushing. The owner must then proceed to repeatedly plunge the toothbrush into the dog's mouth, and manipulate it in a brushing action. Some dogs, with proper orientation and training, can be taught to accept this type of care and remain calm through the process. However, other dogs may become agitated and react defensively. They may pull away, avoid, or bite the conventional “human” toothbrush, making brushing action difficult or impossible. Because of the small size and the exposed hand position on a conventional “human” toothbrush, there is a risk the dog may also bite the owner's hand causing injury to the owner.

In self-directed cleaning with dental chews, the dog is simply given a dental chew and their innate chewing behavior relied upon to clean their teeth. However, there are effectiveness and safety issues with dental chews. Given a dog's typical biting pattern, one spot in its mouth may be favored over others, such that the dog's teeth do not receive equal coverage. Additionally, some dogs may tend to be “big biters” that bite off large pieces of a dental chew at a time. When this occurs, the effectiveness of the dental chew may be compromised, with the dog rapidly consuming the chew without substantial abrasion to the teeth through rhythmic chewing action. Further, large pieces of the dental chew may pose a choking hazard, risking harm to the animal.

In self-directed cleaning with dental ropes, the dog chews upon a rope-like structure similar to as they would a dental chew. However, like dental chews, dental ropes are largely ineffective. While the dog may establish a bite grip on the dental rope, and periodically release to reestablish another bite grip on the dental rope, the dental rope often remains generally stationary in the dog's mouth and preforms little brushing or abrading activity on the teeth or gum line. Over the course of time, the dog may fray the rope, however the actual dental hygiene benefits are often largely negligible.

Accordingly, there is a need for an animal oral hygiene care device and method of use that may address some or all of the deficiencies of prior devices and techniques for cleaning an animal's teeth.

### SUMMARY

Example embodiments of an animal (e.g., dog) oral hygiene care device are provided that promote interactive cleaning of the animal's through social interaction and “play.” Cleaning may be accomplished by effective brushing action that services areas of the mouth neglected by other cleaning devices, for example, both the inside and outside of the animal's teeth and gum line. The device may be structured to protect the owner, (e.g., their hands) from injury while enhancing cleaning by dispensing toothpaste. The animal's active, voluntary participation in the cleaning process may be enhanced by utilizing flavored toothpaste.

In a first embodiment, an animal (e.g., dog) oral hygiene care device is provided that includes a substantially cylindrical shaft arranged to fit within the animal's mouth; a plurality of bristles bonded to the substantially cylindrical shaft and extending radially from an exterior surface thereof; and one or more (e.g., 2) handles respectively disposed at opposing ends of the substantially cylindrical shaft, each handle having a gripping portion disposed perpendicular to a major axis of the shaft to accommodate a wrapping grip by the hand of a human, such as the owner of the animal. The animal oral hygiene care device is used interactively by the human (e.g., owner and the animal), for example by “playing” a “tug and tussle game” with the owner pulling (and/or pushing) upon the handle, and the animal tugging upon the substantially cylindrical shaft with the bristles. As the animal intermittently establishes and releases a bite grip thereupon, and the substantially cylindrical shaft with the bristles an effective brushing action may be achieved.

In a second embodiment, an animal (e.g., dog) oral hygiene care device is provided that includes a substantially cylindrical shaft arranged to fit within the animal's mouth; a plurality of bristles bonded to the substantially cylindrical shaft and extending radially from an exterior surface thereof; one or more (e.g., 2) handles respectively disposed at opposing ends of the substantially cylindrical shaft, each handle having a gripping portion disposed perpendicular to a major axis of the shaft to accommodate a wrapping grip by the hand of a human, such as the owner of the animal; and one or more (e.g., 2) handguards that each at least partially enclose the gripping portion of a respective handle. When such an oral hygiene care device is used interactively by the human (e.g., owner) and the animal, the handguards protect the users hand from inadvertent animal bites (e.g. covering their knuckles and at least a portion of the back of their hand), increasing safety.

In a third embodiment, an animal (e.g., dog) oral hygiene care device is provided that includes a substantially cylindrical shaft arranged to fit within the animal's mouth, the substantially cylindrical shaft having a hollow internal cavity; a plurality of bristles bonded to the substantially cylindrical shaft and extending radially from an exterior surface of the substantially cylindrical shaft; a plurality of holes in the substantially cylindrical shaft extending from the hollow internal cavity to the exterior surface of the substantially cylindrical shaft; and one or more (e.g., 2) handles respectively disposed at opposing ends of the substantially cylindrical shaft, each handle having a gripping portion discs posed perpendicular to a major axis of the shaft to accommodate a wrapping grip by the hand of a human, such as an owner of the animal. An amount of toothpaste (e.g., flavored toothpaste) may be placed in the hollow internal cavity which acts as a reservoir. The toothpaste may be slowly dispensed through the plurality of holes in the substantially cylindrical shaft when the device used interactively by the human (e.g., owner) and the animal, enhancing cleaning effects (and potentially encouraging interaction). Such an embodiment may include or lack handguards, depending on the implementation.

It should be understood that a variety of additional features and alternative embodiments may be implemented other than those discussed in this Summary. This Summary is intended simply as a brief introduction to the reader for the further description that follows, and does not indicate or imply that the examples mentioned herein cover all aspects of the disclosure, or are necessary or essential aspects of the disclosure.

### BRIEF DESCRIPTION OF THE DRAWINGS

The application refers to the accompanying drawings of example embodiments, of which:

FIG. 1A is a top view of a first embodiment of an animal (e.g., dog) oral hygiene care device;

FIG. 1B is a front view of the animal oral hygiene care device in FIG. 1A;

FIG. 1C is a first end view of the animal oral hygiene care device in FIGS. 1A and 1B;

FIG. 2A is a top view of a second embodiment of an animal oral hygiene care deco vice that includes handguards;

FIG. 2B is a bottom view of the animal oral hygiene care device in FIG. 2A;

FIG. 2C is a front view of the animal oral hygiene care device in FIGS. 2A and 2B;

FIG. 2D is a first end view of the animal oral hygiene care device in FIGS. 2A, 2B and 2C;

FIG. 3A is a top view of one implementation of a third embodiment of the animal oral hygiene care device showing internal structure of a hollow internal cavity for toothpaste;

FIG. 3B is a front view of the animal oral hygiene care device in FIG. 3A showing internal structure;

FIG. 3C is a first end view of the animal oral hygiene care device in FIGS. 3A and 3B showing internal structure;

FIG. 4A is a top view of another implementation of the third embodiment of the animal oral hygiene care device that showing internal structure of a hollow internal cavity for toothpaste and handguards;

FIG. 4B is a front view of the animal oral hygiene care device in FIG. 4A; and

FIG. 4C is a first end view of the animal oral hygiene care device in FIGS. 4A and 4B.

### DETAILED DESCRIPTION

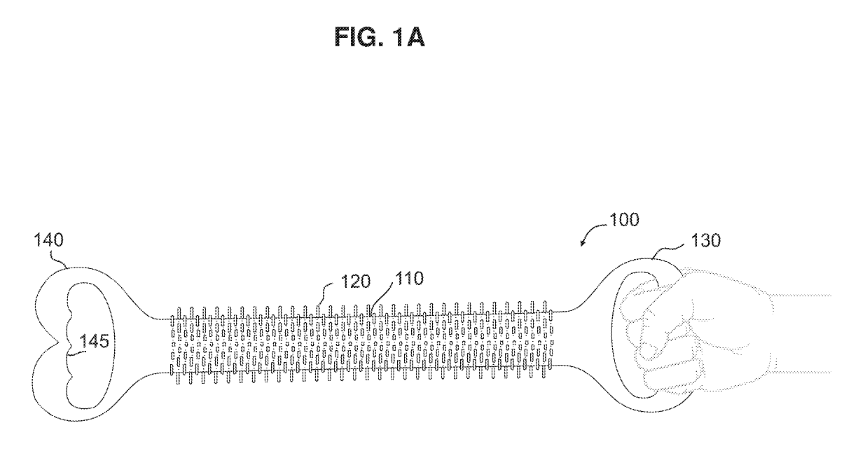

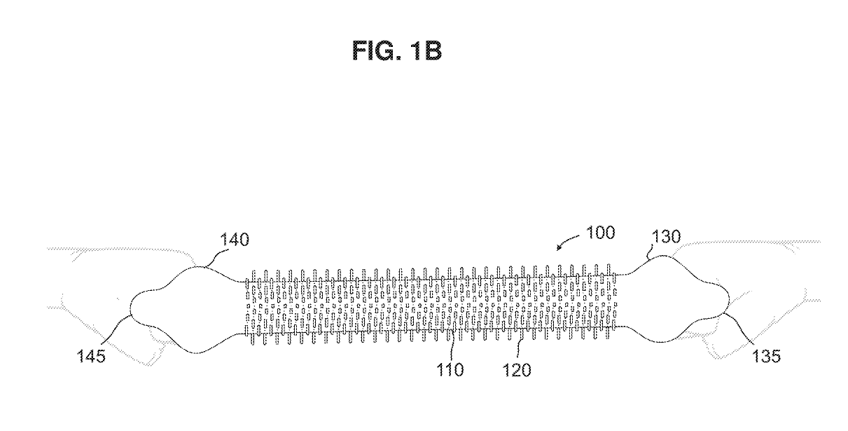

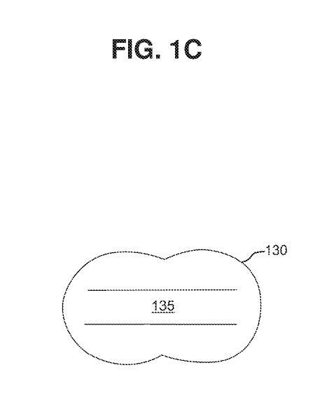

FIGS. 1A, 1B and 1C are respectively a top, front and first end view of a first embodiment of an animal (e.g., dog) oral hygiene care device 100. It should be understood that due to symmetry of the design, a bottom view (not shown) would be substantially identical to the top view, a back view (not shown) would be substantially identical to the front view, and a second end view (not shown) would be substantially identical to the first end view. In the first embodiment, the animal oral hygiene care device 100 includes a substantially cylindrical shaft 110 arranged to fit within the animal's mouth. The size of the substantially cylindrical shaft 110 may be adapted to the particular kind of animal (e.g., a dog, cat, horse, etc.) and breed thereof (e.g., a particular breed of dog), to be thin enough to allow the animal to close its mouth around the shaft. In one implementation, the substantially cylindrical shaft 110 has a diameter of between ½ inch (in) and 1½ in and a length of between 6-14 in. A plurality of bristles 120 are bonded to the substantially cylindrical shaft 110 and extend radially from an exterior surface thereof. In one implementation, the bristles are distributed over substantially all of the exterior surface of the shaft 110, such that they extend in all radial directions. The bristles may have a length sufficient to engage the inside and outside of the tooth and gum line of the animal (e.g., ½ inch), when the animal has closed their mouth around the shaft 110. In one implementation, the bristles are made of a synthetic material (e.g., nylon) and inserted into cores (not shown) during the manufacturing process. First and second handles 130, 140 are respectively disposed at opposing ends of the substantially cylindrical shaft 100. Each handle 130, 140 may have a gripping portion 135, 145 that the animal owner wraps their fingers around. The gripping portions 135, 145 may be disposed perpendicular to a major axis of the shaft 110 and defined by an opening (e.g., an approximately 4 in high by 2.5 in wide opening) through with an animal owner may extend their fingers and establish a wrapping grip. The gripping portions 135, 145 may be substantially cylindrical. In some cases the gripping portions may have features that promote a more secure grip, for example, depressions for individual fingers.

The handles 130, 140 may taper down for a smooth transition into the substantially cylindrical shaft 110. The substantially cylindrical shaft 110 and handles 130, 140 may be integrally formed from one piece of material that is robust enough to withstand animal interaction without deforming, shattering or otherwise prematurely degrading. In some implementations, the material may be a non-toxic thermoplastic rubber that has at least a moderate amount of flexibility and/or pliability. In other implementation the material may be a non-toxic hard plastic. The material may be substantially solid throughout. Alternatively, the material may be hollow, with one or more internal cavities (which may be used to enhance cleaning operation as discussed further below, or may serve no specific purpose, simply being the result of an injection molding process).

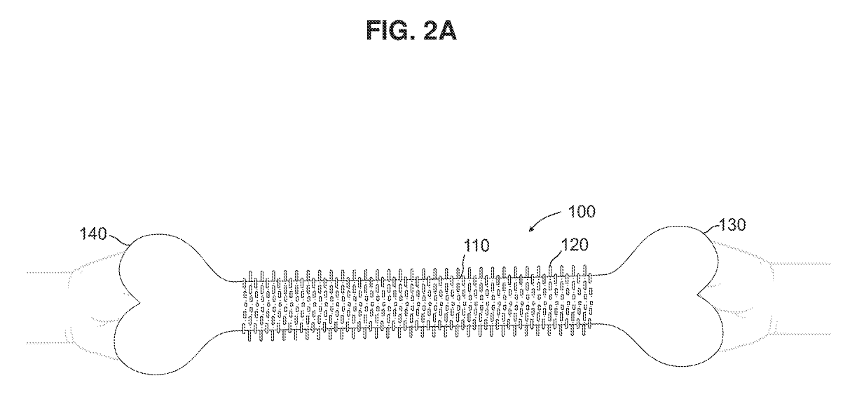

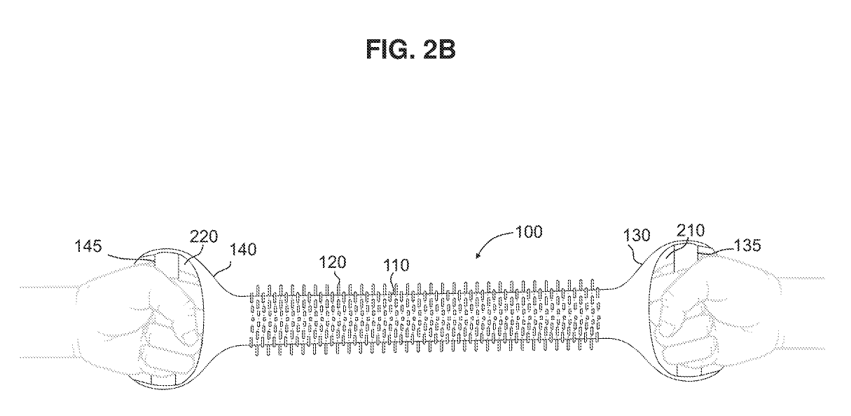

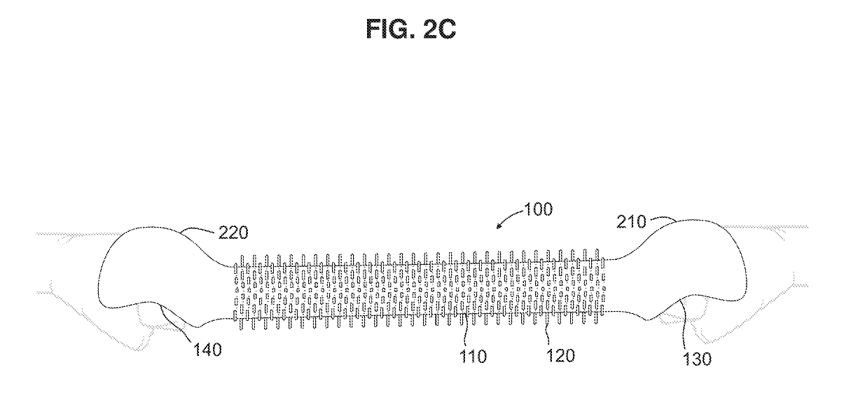

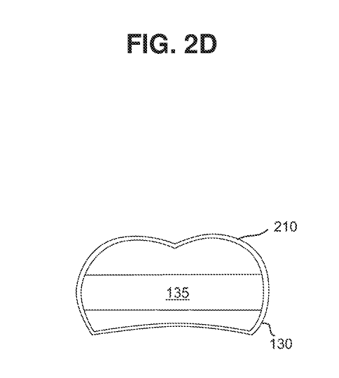

FIGS. 2A, 2B, 2C and 2D are respectively a top, bottom, front and first end view of a second embodiment of an animal (e.g., dog) oral hygiene care device 100. It should be understood that due to symmetry of the design, a back view (not shown) would be substantially identical to the front view, and a second end view (not shown) would be substantially identical to the first end view. In the second embodiment, the animal oral hygiene care device 100 again includes a substantially cylindrical shaft 110 arranged to fit within the animal's mouth, a plurality of bristles 120 are bonded to the substantially cylindrical shaft 110 and extend radially from an exterior surface thereof, sized and configured as in the first embodiment. Further, first and second handles 130, 140 may again be are respectively disposed at opposing ends of the substantially cylindrical shaft 110, having gripping portions 135, 145 disposed perpendicular to a major axis of the shaft 110. However, rather than be fully open, the handguards 210, 220 may at least partially enclose the gripping portion 135, 145 of each handle. The handguards 210, 220 may be sized to cover the knuckles and at least a portion of the back of the hand when the gripping portion 135, 145 are grasp by the owner's hand with a wrapping grip (e.g., extending approximately 2.5 around the back of the owner's hand). Such handguards 210, 220 may serve to protect the hand from inadvertent animal bites, scrapes, etc., thereby increasing safety.

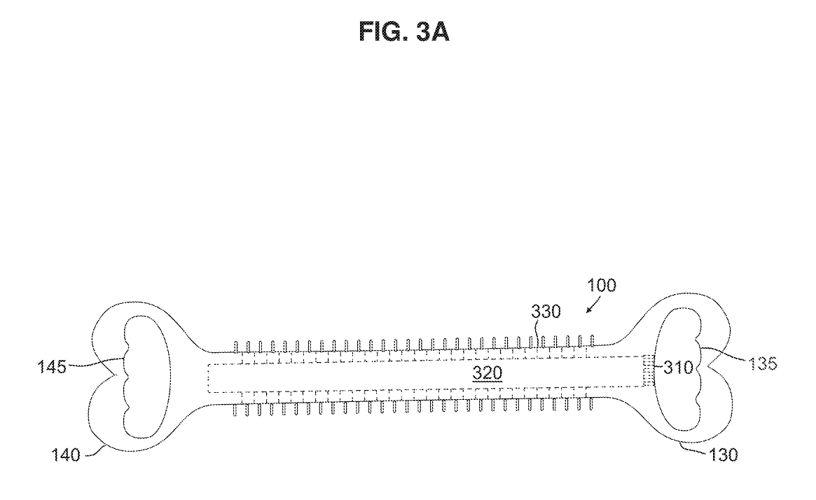

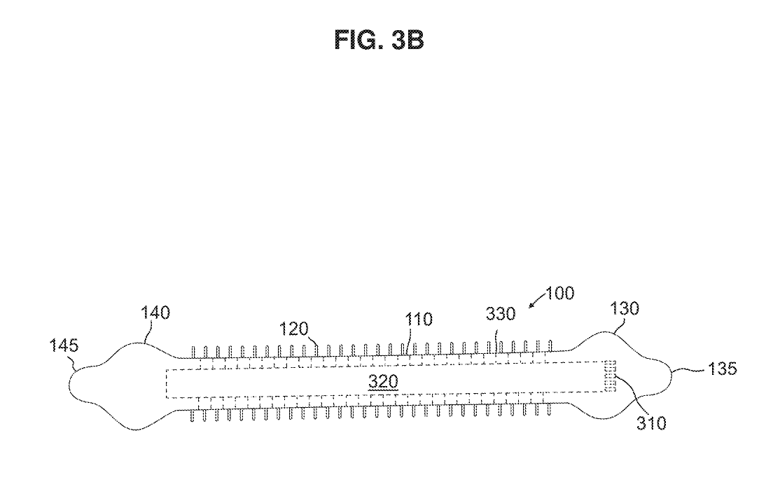

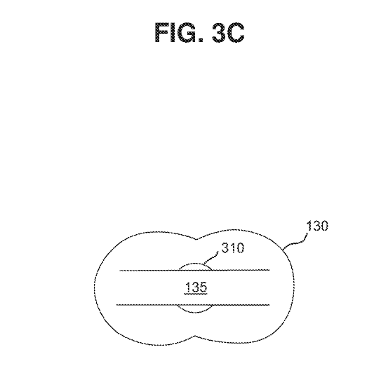

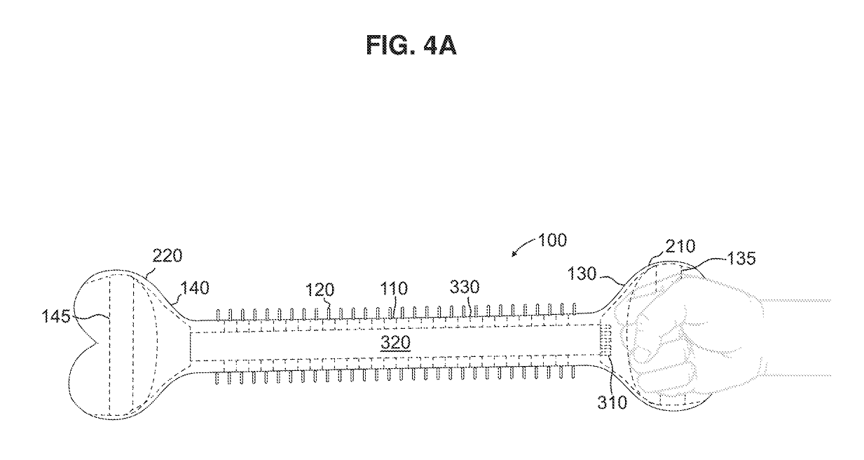

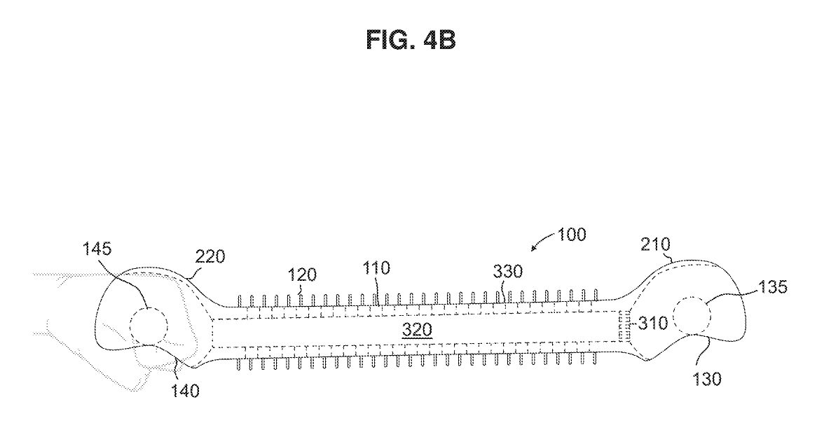

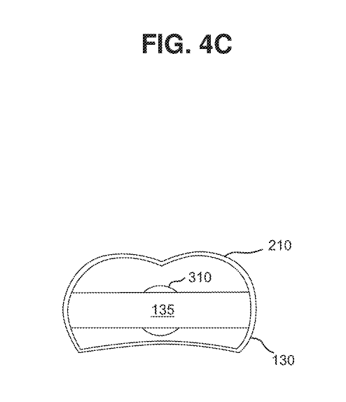

FIGS. 3A, 3B and 3C are respectively a top, front and first end view of one implementation of a third embodiment of an animal (e.g., dog) oral hygiene care device 100, which is based off of the first embodiment discussed above that lacks handguards. It should be understood that due to symmetry of the design, a bottom view (not shown) would be substantially identical to the top view and a back view (not shown) would be substantially identical to the front view, while a second end view (not shown) would be substantially identical to the first end view, with the exception that cap 310 (discussed in more detail below) need not be present on the opposing end. FIGS. 4A, 4B and 4C are respectively a top, front and first end view of another implementation of the third embodiment of an animal (e.g., dog) oral hygiene care device 100, which is based off of the second embodiment discussed above having handguards. Again, it should be understood that due to symmetry of the design, a bottom view (not shown) would be substantially identical to the top view, a back view (not shown) would be substantially identical to the front view, and a second end view (not shown) would be substantially identical to the first end view, with the exception that cap 310 (discussed in more detail below) need not be present on the opposing end. The animal oral hygiene care device 100 again includes a substantially cylindrical shaft 110 arranged to fit within the animal's mouth, a plurality of bristles 120 bonded to the substantially cylindrical shaft 110 and extending radially from an exterior surface thereof, and first and second handles 130, 140 opposing ends of the substantially cylindrical shaft 100, having gripping portions 135, 145 disposed perpendicular to a major axis of the shaft 110. Handguards 210, 220 may be provided (as shown in FIGS. 4A, 4B and 4C) or may not be used (as shown in FIGS. 3A, 3B, 3C and 3D).

The substantially cylindrical shaft 110 may include a hollow internal cavity 320 that extends at least a portion of the length of the substantially cylindrical shaft 110 along its major axis. In one implementation, the hollow internal cavity 320 may be substantially cylindrical, however other shapes may be employed. The hollow internal cavity 320 may be sized (e.g., have a diameter of approximately ¼ inch) to hold an amount of toothpaste, for example, a flavored toothpaste with a flavor appropriate for the type of animal (e.g., meat flavored for dogs). The toothpaste may be deposited in the hollow internal cavity 320 via an opening having a cap 310 disposed in one of the handles 130, 140. The cap may be secured in the opening by a screw connection, a pressure fit or other method of attachment.

A plurality of small holes 330 are arranged in the substantially cylindrical shaft 110 extending from the hollow internal cavity 320 to the exterior surface of the shaft 110. The holes 330 may be equal sized (e.g., diameter of 1/32 in to 1/16 in) or may have varying size depending upon their location in the shaft 110. When the oral hygiene care device 100 is used interactively by the owner and the animal, and the animal intermittently establishes and releases a bite grip on the substantially cylindrical shaft 110, the shaft 110 may be compressed due to the pliability of its construction, and resulting pressure upon toothpaste disposed therein may gradually force some through the holes 330 onto the exterior surface of the shaft 110 and the bristles 120.

The oral hygiene care device 100 according the embodiments discussed above, promotes interactive cleaning of the animal's teeth and gums through social interaction and “play”. The “play” may involve a “tug and tussle game” with the owner pulling (and/or pushing) upon the handle, and the animal voluntarily tugging upon the substantially cylindrical shaft 110 with the bristles 120. As the animal intermittently establishes and releases a bite grip upon the substantially cylindrical shaft 110 with the bristles 120, an effective brushing action may be achieved. In embodiments with a hollow internal cavity 320 filled with toothpaste, cleaning action may be enhanced by the release of the toothpaste through the holes 330. If flavored toothpaste is used, it may serve to enhance the animal's interest and promote active, voluntary participation. Since the animal is interpreting the cleaning process as “play”, the animal is likely to be relaxed. They can always end the “play” and walk away if they feel uneasy. As such, rather than be a stressful experience, a cleaning session with the oral hygiene care device 100 may serve to reinforce a loving bond between the owner and the animal.

The oral hygiene care device 100 and its use in interactive cleaning of an animal's teeth through social interaction and “play” may have a number of advantages over prior devices and cleaning techniques. For example, the oral hygiene care device 100 may provide enhanced cleaning action. Due to the sizing of the substantially cylindrical shaft 110 that may allow an animal to closed its mouth around it, the coverage of bristles 120 extending radially from the shaft 110, the dispensing of toothpaste from a hollow internal cavity 320 (in some embodiments), and other features, the oral hygiene care device 100 may service areas of the mouth neglected by other cleaning devices, and/or clean them more effectively than other devices. As an added benefit, the oral hygiene care device 100 may scrub the animal's tongue during use, remediating halitosis.

Further, the oral hygiene care device 100 may effectively protect the owner (e.g., their hand) from injury. As mentioned above, since the animal is interpreting the cleaning as “play” in which they are voluntarily participating, they are unlikely to feel cornered or frightened. This stands in contrast to prior owner-manipulated cleaning processes where an owner plunges a foreign object (e.g., a conventional “human” toothbrush) in and out of their mouths. Since animals typically bite when stressed, the chances of owner injury may be greatly reduced. Further safety may be promoted by the handguards 210, 220, which may protect the owner from inadvertent scraping or bumping against the animal's teeth.

Finally, dispensing flavored toothpaste may operate as a reinforcement and reward mechanism for the cleaning activity, encouraging the animal to actively participate and even seek out the “play” on a regular basis. This may better promote better oral hygiene patterns than with prior devices and techniques.

While example embodiments of an animal oral hygiene care device are discussed above that promote interactive cleaning of the animal's teeth and gums through social interaction and “play”, it should be understood that a number of modifications and/or additions may be made without departing from the disclosure's intended spirit and scope. For example, the animal oral hygiene care device may be constructed in different sizes than discussed above, from different materials than discussed above, and include different or additional structures than discussed above. While it is discussed above that animal oral hygiene care device may be used by an “owner” of the animal, it should be understood that the device may be used by various human user's, and that term “owner” should be interpreted broadly to encompass any human that provides care or maintenance to the animal, on a permanent or short term basis, regardless of whether they have an actual financial ownership interest in the animal. Above all, it should be understood that the above descriptions are meant to be taken only by way of example. What is claimed is:

1. An animal oral hygiene care device that promotes the animal's active participation in the cleaning process, comprising:
a shaft arranged to fit within the animal's mouth;
a plurality of bristles bonded to the shaft and extending radially from an exterior surface of the shaft; and
one or more handles respectively disposed at ends of the shaft, each handle having a gripping portion disposed perpendicular to a major axis of the shaft to accommodate a wrapping grip by a hand of a human.

2. The animal oral hygiene care device of claim 1, where the animal is a dog and the shaft is sized to have a diameter between ½ inch (in) and 1½ in, and a length of between 6 in and 14 in.

3. The animal oral hygiene care device of claim 1, wherein the plurality of bristles extend radially from the exterior surface of the shaft in all radial directions.

4. The animal oral hygiene care device of claim 1, wherein the one or more handles are two handles disposed at opposing ends of the shaft.

5. The animal oral hygiene care device of claim 1, wherein the shaft and one or more handles are integrally formed from one piece of material.

6. The animal oral hygiene care device of claim 1, further comprising:
one or more handguards that at least partially enclose the gripping portion of a respective handle.

7. The animal oral hygiene care device of claim 6, wherein the one or more handguards each are arranged to cover knuckles and at least a portion of a back of the hand when the gripping portion is grasp by the hand of the human.

8. The animal oral hygiene care device of claim 1, wherein there shaft includes a hollow internal cavity, and the animal oral hygiene care device further comprises:
a plurality of holes in the shaft extending from the internal cavity to the exterior surface of the shaft; and
an amount of toothpaste placed in the hollow internal cavity,
wherein the plurality of holes are arranged to dispense the toothpaste in the cleaning process.

9. The animal oral hygiene care device of claim 8, further comprising:
an opening having a cap disposed in one of the one or more handles and extending into the internal cavity.

10. An animal oral hygiene care device that promotes the animal's active participation in the cleaning process, comprising:
a shaft arranged to fit within the animal's mouth;
a plurality of bristles bonded to the shaft and extending radially from an exterior surface of the shaft;
one or more handles respectively disposed at ends of the shaft, each handle having a gripping portion disposed perpendicular to a major axis of the shaft to accommodate a wrapping grip by a hand of a human; and
one or more handguards that at least partially enclose the gripping portion of a respective handle.

11. The animal oral hygiene care device of claim 10, wherein the one or more handguards each are arranged to cover knuckles and at least a portion of a back of the hand when the gripping portion is grasp by the hand of the human.

12. The animal oral hygiene care device of claim 10, where the animal is a dog and the shaft is sized to have a diameter between ½ inch (in) and 1½ in, and a length of between 6 in and 14 in.

13. The animal oral hygiene care device of claim 10, wherein the plurality of bristles extend radially from the exterior surface of the shaft in all radial directions.

14. The animal oral hygiene care device of claim 10, wherein the one or more handle are two handles disposed at opposing ends of the shaft.

15. The animal oral hygiene care device of claim 10, wherein the shaft and one or more handles are integrally formed from one piece of material.

16. The animal oral hygiene care device of claim 1, wherein there shaft includes a hollow internal cavity, and the animal oral hygiene care device further comprises:
a plurality of holes in the shaft extending from the hollow internal cavity to the exterior surface of the shaft; and
an amount of toothpaste placed in the hollow internal cavity,
wherein the plurality of holes are arranged to dispense the toothpaste in the cleaning process.

17. The animal oral hygiene care device of claim 16, further comprising:
an opening having a cap disposed in one of the one or more handles extending into the internal cavity.

18. An animal oral hygiene care device that promotes the animal's active participation in the cleaning process, comprising:
a shaft arranged to fit within the animal's mouth, the shaft having a hollow internal cavity;
a plurality of bristles bonded to the shaft and extending radially from an exterior surface of the shaft;
a plurality of holes in the shaft extending from the hollow internal cavity to the exterior surface of the shaft;
one or more handles respectively disposed at ends of the shaft, each handle having a gripping portion disposed perpendicular to a major axis of the shaft to accommodate a wrapping grip by a hand of a human; and
an amount of toothpaste placed in the hollow internal cavity,
wherein the plurality of holes are arranged to dispense the toothpaste in the cleaning process.

19. The animal oral hygiene care device of claim 18, further comprising:
an opening having a cap disposed in one of the one or more handles extending into the internal cavity.

20. The animal oral hygiene care device of claim 18, where the animal is a dog and the shaft is sized to have a diameter between ½ inch (in) and 1½ in and a length of between 6 in and 14 in.
